(19) United States
(12) Patent Application Publication
(10) Pub. No.: US 2010/0134368 A1
(43) Pub. Date: Jun. 3, 2010

(54) INHOMOGENEOUS LENS WITH MAXWELL'S FISH-EYE TYPE GRADIENT INDEX, ANTENNA SYSTEM AND CORRESPONDING APPLICATIONS

(75) Inventors: Olivier Lafond, Gosne (FR); Mohamed Himdi, Rennes (FR); Sebastien Rondineau, Saint-Brcvin-Lcs-Pins (FR); Benjamin Fuchs, Rennes (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: Universite de Rennes 1, Rennes Cedex (FR)

(21) Appl. No.: 11/994,769

(22) PCT Filed: Jul. 5, 2006
(86) PCT No.: PCT/EP06/63912

§ 371 Date: Jun. 9, 2008

(30) Foreign Application Priority Data
Jul. 5, 2005 (FR) 0507188

(51) Int. Cl. H01Q 19/06; H01Q 15/02

(52) U.S. Cl. 343/754; 343/911 R; 343/753

(57) ABSTRACT

The invention concerns an inhomogeneous lens with Maxwell's Fish-eye type gradient index (1), made in the shape of a hemisphere. The invention is characterized in that the lens comprises N hemispheric concentric shells (2 to 4), with different discrete dielectric constants and mutually interlaced without void between the two successive shells, with 3≦N≦20, the discrete dielectric constants of the N shells being such that they define a discrete distribution close to the theoretical distribution of the index inside the lens.

### CROSS-REFERENCE TO RELATED APPLICATIONS

This Application is a Section 371 National Stage Application of International Application No. PCT/EP2006/063912, filed Jul. 5, 2006 and published as WO 2007/003653 A1 on Jan. 11, 2007, not in English.

### FIELD OF THE DISCLOSURE

The field of the disclosure is that of lens-type focusing systems, which can be used at hyperfrequencies and in particular at millimeter waves.

More specifically, the disclosure relates to an inhomogeneous lens with a gradient index, of the Maxwell's fish-eye type.

The disclosure also relates to an antenna system combining such a lens with one or more source antennas.

The disclosure has numerous applications, such as, for example, high-speed satellite communications, digital satellite television, anti-collision radar applications in motor vehicles, etc.

In the case of the first application mentioned above, namely high-speed satellite communications, the antenna system according to the disclosure can be used as a source of a reflector (for example in the 50 GHz band).

For the second application mentioned above, namely digital satellite television, it is necessary when subscribers want access to two satellites for there to be two different sources illuminating the parabola. The antenna system according to the disclosure, in one of its configurations, can make it possible to shift the beam so as to replace said two sources with a single one.

Finally, in the third application mentioned above, namely motor vehicles, in the case of the future anti-collision radars at 77 GHz, long-range (200 m) and short-range, single- or multi-beam antennas, will be used. In the case of the long range, an antenna system according to the disclosure (i.e. a “lens antenna”) can make it possible to achieve the directivity necessary, and the gradient index aspect can lead to beneficial size and weight reductions. Currently, the beam of the antenna located in front of the vehicle is stationary, but it would be beneficial to shift the beam slightly so as to be more precisely aligned with the road. The antenna system according to the disclosure, in one of its configurations, can make it possible to change the direction of the beam over a sufficient angle.

### BACKGROUND OF THE DISCLOSURE

Among all of the lens-type focusing systems used at hyperfrequencies, and in particular at millimeter waves, a major category is called “Inhomogeneous lenses with a gradient index”. These lenses are inhomogeneous balls of which the dielectric constant changes according to the distance to the center. These spherical lenses with a gradient index allow for a significant weight reduction.

In the literature, a number of types of lenses with a gradient index allow for focusing. Variable index laws are optimized in order to minimize the differences in optical length between the different paths. The most widely known are the following distributions, in which R is the radius of the lens:

Lüneburg distribution: εᵣ(r)=2−(r/R)², (Lüneburg 1944; Rozenfeld 1976; D. Greenwood 1999),

Eaton distribution: εᵣ(r)=(r/R)²,

Eaton-Lippman distribution: εᵣ(r)=(2R−r/r), (Rozenfeld 1976),

Maxwell's fish-eye distribution: εᵣ(r)=4/(1+(r/R)²)².

In the case of the Lüneburg lens, each point of the surface is an ideal focal point. The Eaton-Lippman distribution reacts like a mirror: the object and image points are perfectly coincident. This is an omnidirectional reflector.

In the case of Maxwell's fish-eye, the object and image points are diametrically opposed on the exterior surface of the lens. Thus, by symmetry, a planar wave is formed on the median plane. This explains the use of only a half-sphere (or semi-sphere) to focus the radiation. It is this last half-sphere aspect that is particularly beneficial for the Maxwell's fish-eye lens, because this lens allows for a beneficial size reduction for the intended applications. The lens of the present invention belongs to this category of lens.

In the context of this invention, we are interested in the technique for producing this type of lens with a gradient index.

As can easily be noted, the distribution of the dielectric constant is continuous in the Maxwell's fish-eye lens, as in the Lüneburg lens. It is therefore impossible to strictly follow this law when producing the lens.

Among the solutions found for dealing with these non-linear laws, the examples found in the literature concern exclusively the Lüneburg lens.

Thus, since the 1960s, the Emerson & Cumming company has, for example, produced a Lüneburg lens by overlapping a plurality of homogeneous concentric shells, in the shape of a sphere, with different indices. It has also been proposed to produce Lüneburg lenses by inserting air holes in a Teflon sphere (registered trademark). The number of holes and their diameters are optimized so that the artificial law best follows the theoretical law. However, this last technique is also mechanically complex because the number of holes is prohibitive.

Neither of these two known solutions, specific to the Lüneburg lens, can be transposed to the production of a Maxwell's fish-eye lens.

Moreover, in spite of the fact that the Maxwell's fish-eye lens has been known theoretically for a very long time, the inventors have found no bibliographic reference to any known technique for producing this type of lens.

### SUMMARY

An aspect of the disclosure relates to an inhomogeneous lens with a gradient index, of the Maxwell's fish-eye type, produced in the form of a semi-sphere, with different discrete dielectric constants overlapping one another without any empty spaces between two successive shells, with 3≦N≦20, wherein the discrete dielectric constants of the N shells are such that they define a discrete distribution approximating the theoretical distribution of the index inside the lens.

It is important to note that, in the technique of an embodiment of the invention, unlike in the known technique mentioned above for producing the Lüneburg lens, the shells do not all have the same dielectric constant, and there is not air-filled space between two successive shells.

It should also be noted that a number of shells greater than 20 would make the production complex and expensive.

Preferably, the N shells have discrete dielectric constants ε₁, ε₂ . . . ε_{N} and standardized external radii d₁, d₂ . . . d_{N}, with d_{N}=1, so that they minimize the following function:

Δ=∫₀^{d}^{₁}|εᵣ(r)−ε₁|^{q}dv+∫_{d}_{₁}^{d}^{₂}|εᵣ(r)−ε₂|^{q}dv+ . . . +∫_{d}_{_{N-1}}¹|εᵣ(r)−ε_{N}|^{q}dv

with q=∞ and in which:

$${\vert {ɛ}_{r} ( r ) - {ɛ}_{i} \vert}^{∞} = {sup}_{r ∈ [ {r}_{i - 1} , {r}_{i} ]} \vert {ɛ}_{r} ( r ) - {ɛ}_{i} \vert ,$$

with i representing the number of the shell concerned

dv=2πr²dr

εᵣ( ) is the theoretical distribution of the index inside of the lens, and dv is a volume element.

In this document, the term “standardized external radius” refers to an external radius standardized with respect to the maximum external radius (i.e. that of the external shell: d_{N}=1).

Advantageously, the lens includes three shells, called a central shell, an intermediate shell and an external shell, of which the standardized external radii are respectively: d₁, d₂ and d₃, and of which the standardized radial thicknesses are respectively equal to: d₁, d₂−d₁, and d₃−d₂ to the nearest hundredth.

An analysis by the spherical modes enabled the inventors to show that a limited number of shells for producing the lens, namely three, is enough to provide a satisfactory level of secondary lobes. Indeed, a lens according to an embodiment of the invention constituted by only three shells makes it possible to obtain, for example, a level of secondary lobes of around −20 dB with respect to the main lobe, which proves that the focusing is done properly.

In a particular embodiment of the lens according to the invention, the standardized external radii are respectively equal to: d₁=0.43, d₂=0.70 and d₃=1 to the nearest hundredth, and the dielectric constants of the central, intermediate and external shells are respectively equal to 3.57, 2.72 and 1.86 to the nearest hundredth.

According to an alternative, the N shells have discrete dielectric constants ε₁, ε₂ . . . ε_{N} and standardized external radii d₁, d₂ and d_{N}, with d_{N}=1, so that they minimize the following function:

Δ=∫₀^{d}^{₁}|εᵣ(r)−ε₁|dv+∫_{d}_{₁}^{d}^{₂}|εᵣ(r)−ε₂|dv+ . . . +∫_{d}_{_{N-1}}¹|εᵣ(r)−ε_{N}|dv

where εᵣ( ) is the theoretical distribution of the index inside of the lens, and dv is a volume element.

In a first specific embodiment of this alternative, the standardized external radii are respectively equal to: d₁=0.57, d₂=0.79 and d₃=1 to the nearest hundredth, and the dielectric constants of the central, intermediate and external shells are respectively equal to 2.77, 1.81 and 1.19 to the nearest hundredth.

It is clear that other embodiments can be envisaged without going beyond the context of the present invention.

An embodiment of the invention also relates to an antenna system including a lens according to an embodiment of the invention (as mentioned above), associated with at least one source antenna.

Advantageously, said at least one source antenna belongs to the group including:

printed antennas;

waveguides;

horn antennas; and

wire antennas.

Advantageously, the system includes positioning means making it possible to place said at least one source antenna at a distance h from the lens, and in a position contained in the focal spot of this lens. Indeed, said lens has a focal spot due to the fact that the index distribution obtained with said concentric shells is discrete (and is therefore only an approximation, with a limited number of shells, of the theoretical continuous distribution. This focal spot is located outside the lens and at a predetermined distance h from the lens.

Advantageously, the positioning means include at least one spacer made of a dielectric material of which the dielectric permittivity approximates that of the air and makes it possible to position the lens with respect to said at least one source antenna.

According to an advantageous alternative, the positioning means include an additional shell, of which the dielectric permittivity approximating that of the air has a shape fitting the external surface of the lens, and at least one portion of said source antenna is conformed directly to the external surface of said additional shell.

Thus, the bulk of the antenna system is reduced.

According to an advantageous feature, the system includes a single source antenna that is an antenna printed on air and fed through a slot.

Thus, unlike the alternative consisting of using a printed antenna array, with a single source antenna of this type, the dielectric losses are absent and the directivity of this type of antenna (patch) is very significant (9-10 dBi) due to the very low permittivity of the substrate (air). Moreover, this solution makes it possible to obtain very good radiation properties (openings, lobes, directivity) by comparison with the solution involving a source array.

In an advantageous embodiment of the invention, the focal spot of said lens is used due to the fact that the index distribution obtained with said concentric shells is discrete. This focal spot is located outside the lens and at a predetermined distance h from the lens. For this, the system also includes means for de-centering said at least one source antenna with respect to the axis of the lens, enabling said at least one source antenna to successively occupy at least two different positions contained in said focal spot, so as to allow for scanning, over an angular sector, of the beam focused at the output of the lens.

We thus take advantage of the fact that, as the law of the index in the lens according to an embodiment of the invention is discrete (and not continuous), the lens according to an embodiment of the invention has a focal spot (and not a single focal point), which makes it possible to shift the beam or obtain multi-beam patterns. In other words, the fact that there is a focal spot makes it possible to move the source under the lens and thus to obtain a scanning, on a predetermined angular sector, of the focused beam.

An embodiment of the invention also relates to a use of the antenna system according to an embodiment of the invention in the shifting of the beam at the output of the lens.

An embodiment of the invention also relates to a use of the antenna system according to an embodiment of the invention to obtain a multi-beam diagram.

### BRIEF DESCRIPTION OF THE DRAWINGS

Other features and advantages will appear on reading the following description of a preferred embodiment of the invention, provided by way of an indicative and non-limiting example, and the appended drawings, in which:

FIGS. 1a and 1b show a perspective view and a cross-section view, respectively, of a first specific embodiment of an antenna system according to the invention, combining a Maxwell's fish-eye lens according to an embodiment of the invention with a source antenna array;

FIG. 2 shows a top view of a specific embodiment of a Maxwell's fish-eye lens according to the invention, capable of being used in the antenna system of FIGS. 1a and 1b;

FIG. 3 shows the curve of a 3^{rd} degree polynomial approximating the theoretical distribution of the index inside a Maxwell's fish-eye lens according to an embodiment of the invention, as well as parameters α, β, and γ involved in a calculation for optimizing the parameters of the various shells forming the Maxwell's fish-eye lens in a specific embodiment of the invention;

FIGS. 4a and 4b show the results of a first example of a Maxwell's fish-eye lens according to the invention, in terms of the electrical field and the power density, respectively;

FIGS. 5a and 5b show the results of a second example of a Maxwell's fish-eye lens according to an embodiment of the invention, in terms of the electrical field and the power density, respectively;

FIGS. 6a, 6b and 6c show a top view, a bottom view and a cross-section view, respectively, of a specific embodiment of the antenna array shown in FIGS. 1a and 1b;

FIGS. 7a and 7b show a bottom view and a cross-section view, respectively, of a first embodiment of a patch on air (non-conformal, vertical linear polarization), capable of being combined with a Maxwell's fish-eye lens according to an embodiment of the invention;

FIG. 8 shows a bottom view of a second embodiment of a patch (non-conformal, bipolarization), capable of being combined with a Maxwell's fish-eye lens according to an embodiment of the invention;

FIG. 9 shows a bottom view of a third embodiment of a patch (non-conformal, circular polarization), capable of being combined with a Maxwell's fish-eye lens according to an embodiment of the invention; and

FIG. 10 shows a cross-section view of a second specific embodiment of an antenna system according to the invention, combining a Maxwell's fish-eye lens according to an embodiment of the invention with a conformal antenna array.

### DETAILED DESCRIPTION OF ILLUSTRATIVE EMBODIMENTS

In all of the figures of the present document, identical elements are designated by the same numeric reference.

An embodiment of the invention therefore relates to an inhomogeneous Maxwell's fish-eye lens with a gradient index, as well as an antenna system combining this lens with one or more source antennas.

The Maxwell's fish-eye lens according to an embodiment of the invention includes N semi-spherical shells, with 3≦N≦20. N is directly dependent on the size of the lens. The larger the lens is, the more the number N of shells must be increased in order to approximate the theoretical law of distribution of the index inside the lens.

The shells are concentric, with different discrete dielectric constants overlapping one another without any empty spaces between two successive shells. Thus, we obtain a lens of which the discrete distribution best approximates the theoretical distribution of the index inside the lens, namely:

εᵣ(r)=4/(1+(r/R)²)², with R being the radius of the lens.

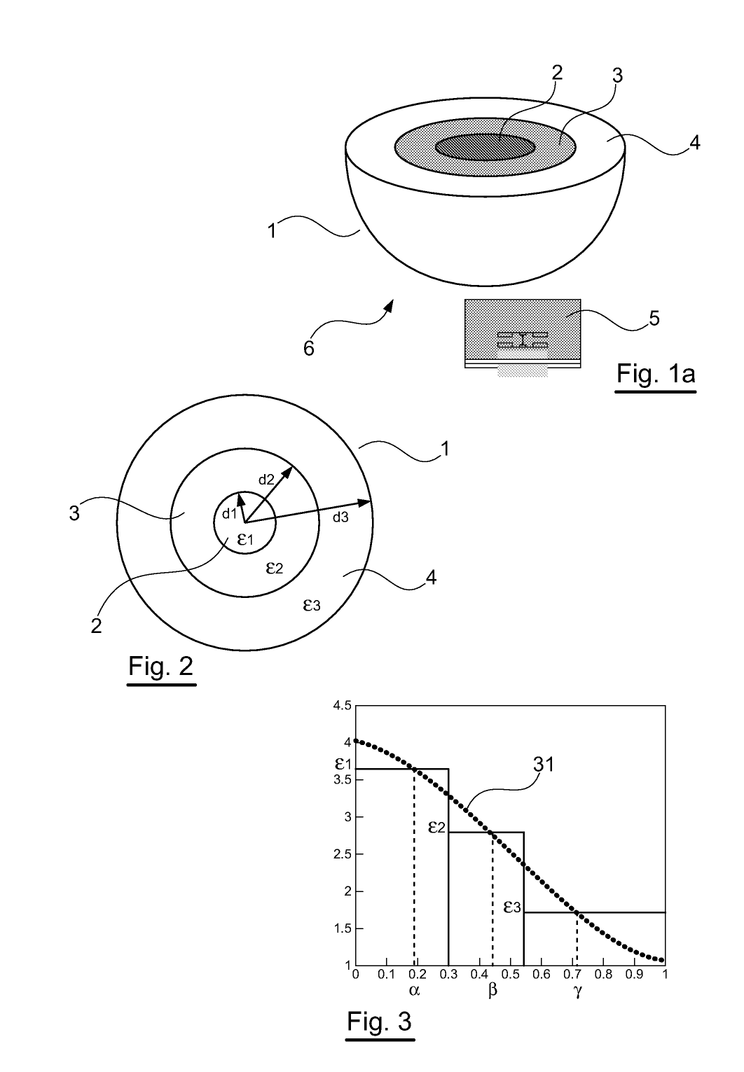

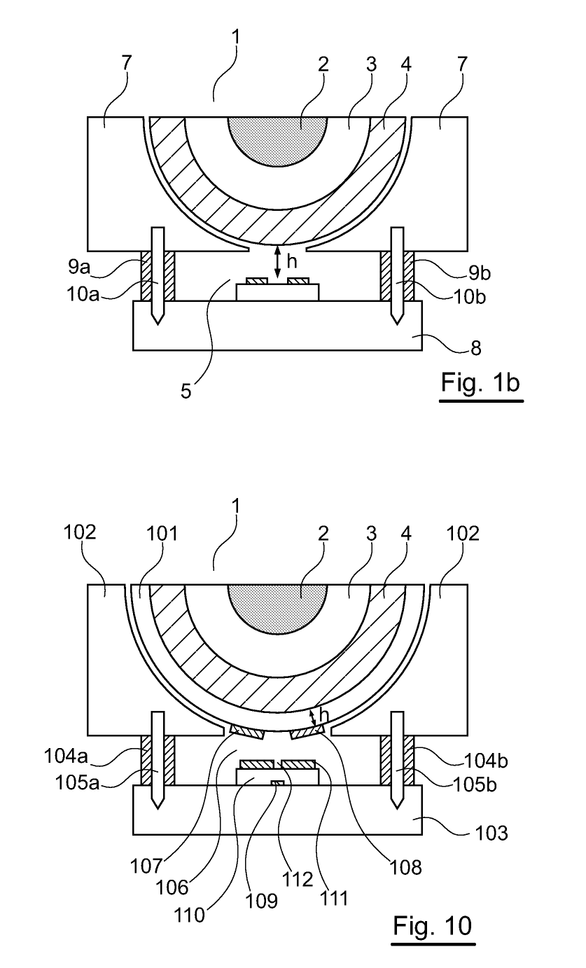

We will now present, in relation to FIGS. 1a and 1b (seen in perspective and cross-section views, respectively), a first specific embodiment of the antenna system according to claim 6. For the sake of simplification of FIG. 1a, the means for positioning the lens with respect to the source are shown only in FIG. 1b.

In this particular embodiment, the Maxwell's fish-eye lens 1 includes three shells, called a central shell 2, an intermediate shell 3 and an external shell 4.

As shown in FIG. 2 (top view), the standardized external radii of these shells 2 to 4 are respectively:
d₁, d₂ and d₃. Their standardized radial thicknesses are respectively equal to: d₁, d₂−d₁ and d₃−d₂ to the nearest hundredth. Their dielectric constants (dielectric permittivities) are respectively equal to: ε₁, ε₂ and ε₃.

As shown in FIG. 3, the inventors have performed a calculation for optimizing the parameters of the three shells forming the Maxwell's fish-eye lens in this particular embodiment of the invention.

First, the theoretical law of the index in the lens has been approximated by a 3^{rd} degree polynomial in order to simplify the calculations. The following was thus obtained:

$${ɛ}_{r} ( r ) = \frac{4}{{( 1 + {r}^{2} )}^{2}} \approx 4.36 {x}^{3} - 6.69 {x}^{2} - 0.66 x + 4.04$$

The curve of this polynomial is referenced 31 in FIG. 3. It is perfectly superimposed with the curve of the theoretical law.

Then, the optimization of the different shells (εi, di) involves minimizing the following first cost function:

Δ=∫₀^{d}^{₁}|εᵣ(r)−ε₁|^{q}dv+∫_{d}_{₁}^{d}^{₁}|εᵣ(r)−ε₂|^{q}dv+ . . . +∫_{d}_{_{N-1}}¹|εᵣ(r)−ε_{N}|^{q}dv

with q=∞ and in which:

$${\vert {ɛ}_{r} ( r ) - {ɛ}_{i} \vert}^{∞} = {sup}_{r ∈ [ {r}_{i - i} , {r}_{i} ]} \vert {ɛ}_{r} ( r ) - {ɛ}_{i} \vert ,$$

with i representing the number of the shell concerned

dv=2πr²dr

εᵣ( ) is the theoretical distribution of the index inside of the lens, and dv is a volume element.

It should be noted that this first cost function is original due to the fact that the optimization is done on the volume of the half-sphere and not on a 2D cross-section view (stair steps).

In a particular embodiment of the lens according to the invention, after optimization with the first cost function, and by choosing N equal to three, by way of an example, the standardized external radii are respectively equal to: d₁=0.43, d₂=0.70 and d₃=1 to the nearest hundredth, and the dielectric constants of the central, intermediate and external shells are respectively equal to 3.57, 2.72 and 1.86 to the nearest hundredth.

It is clear that this first cost function can be used for other values of N (3≦N≦20).

In an alternative, and by choosing N equal to three, by way of an example, the following second cost function is minimized:

Δ_{absolue}=∫_{coquille1}|εᵣ(r)−ε₁|dv+∫_{coquille2}|εᵣ(r)−ε₂|dv+∫_{coquille3}|εᵣ(r)−ε₃|dv

in which the volume element is:

$$d v = \frac{2}{3} π {r}^{3} - \frac{2}{3} {π ( r - d r )}^{3} \approx 2 π {r}^{2} d r ( of the {1}^{st} order )$$

This therefore amounts to a minimization of the expression:

Δ_{absolue}=∫₀^{d}^{₁}|εᵣ(r)−ε₁|2πr²dr+∫_{d}_{₁}^{d}^{₂}|εᵣ(r)−ε₂|2πr²dr+∫_{d}_{₂}¹|εᵣ(r)−ε₃|2πr²dr

Δ_{absolue}=∫₀^{α}[εᵣ(r)−ε₁]2πr²dr+∫_{α}^{d}^{₁}[ε₁−εᵣ(r)]2πr²dr+∫_{d}_{₁}^{β}[εᵣ(r)−ε₂]2πr²dr+∫_{β}^{d}^{₂}[ε₂−εᵣ(r)]2πr²dr +∫_{d}_{₂}^{γ}[εᵣ(r)−ε₃]2πr²dr+∫_{γ}¹[ε₃−εᵣ(r)]2πr²dr

The variables α, β, and γ are shown in FIG. 3.

The inventors first optimized the radii d₁, d₂ and d₃ by fixing the dielectric constants of the three shells at: ε₁=4, ε₂=2.5 and ε₃=1.5. The result of this optimization is the following: d₁=0.33, d₂=0.65 and d₃=1. We use, for example, the following materials sold by the Emerson & Cumming company, of which the names are:

Eccostock K=4, for εᵣ=4;

Eccostock K=2.5, for εᵣ=2.5;

Eccostock K=1.5, for εᵣ=1.5;

Then, to find other optimal solutions with dielectric constants and different radii, a number of cases have been distinguished:

one or two dielectric constants are fixed and the radii are optimized;

the dielectric constants are all variables as are the radii;

The following table summarizes the results obtained (the last line of this table corresponds to the optimal case):

| | | Standardized | | |
|---|---|---|---|---|
| | | radii | Destandardized | |
| | | d1 and d2 | radii with respect | Final |
| Variables | Permittivities | (with d3 = 1) | to R = 12 mm | error |
| 4, 2.5, 1.5 | 4, 2.5, 1.5 | 0.33, 0.65 | 3.96, 7.8 | 0.0929 |
| 4, ε₂, ε₃ | 4, 2.18, 1.24 | 0.37, 0.72 | 4.44, 8.64 | 0.0778 |
| ε₁, 2.5, ε₃ | 3.2, 2.5, 1.28 | 0.43, 0.67 | 5.16, 8.04 | 0.0738 |
| ε₁, ε₂, 1.5 | 2.95, 2.1, 1.5 | 0.51, 0.70 | 6.12, 8.4 | 0.0801 |
| ε₁, ε₂, ε₃ | 2.77, 1.81, 1.19 | 0.57, 0.79 | 6.84, 9.48 | 0.0592 |

The results are very interesting, because they make it possible to see that a good approximation of the theoretical law can be obtained by various radii and dielectric constants for the shells. In a certain way, the production technique is generalized. Of course, these results are not exhaustive because it is entirely possible to find other optimized solutions if one or more other dielectric constants are fixed at the outset.

A first example of a Maxwell's fish-eye lens according to the invention (after optimization with the second cost function), consistent with the first line of the table above, was tested in terms of the electrical field and the power density. The radii d₁, d₂, and d₃ are respectively 4, 8 and 12 mm. The dielectric constants are respectively 4, 2.5 and 1.5.

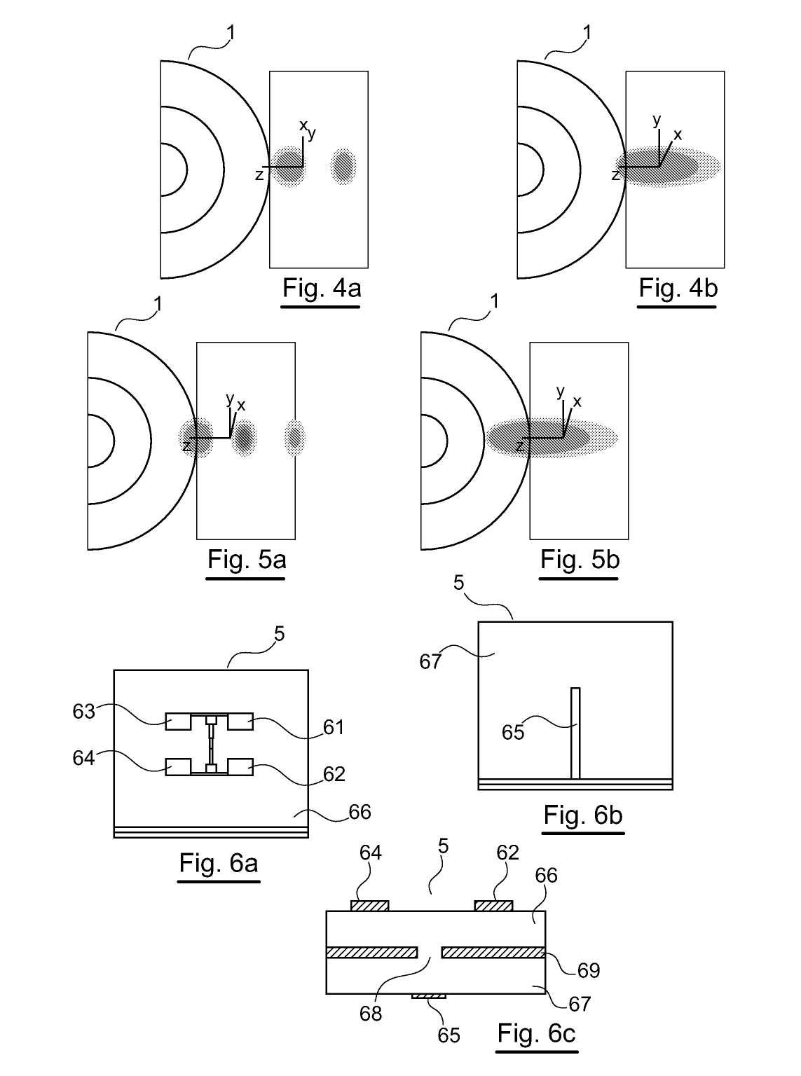

The results for this first test (lens 1 illuminated by a planar wave) are represented in terms of the electrical field (V/m) in FIG. 4a, and in terms of the power density (VA/m) in FIG. 4b. In FIG. 4a, it can be seen that the field is well focused, in the form of a focal spot (and not a single focal point), on the other side of the lens 1 with respect to the planar wave. FIG. 4b makes it possible to see that the focusing is done outside of the lens 1, which makes it possible (as explained in detail below) to have a printed source illuminating the lens. The distance between the source and the lens can be optimized to obtain the desired radioelectric properties (gain, radiation diagram, etc.).

A second example of a Maxwell's fish-eye lens according to the invention (after optimization with the second cost function), consistent with the last line of the table above, was tested in terms of the electrical field and the power density. The radii d₁, d₂, and d₃ are respectively 6.84, 9.48 and 12 mm. The dielectric constants are respectively 2.77, 1.81 and 1.19.

The results for this second test are represented in terms of the electrical field (V/m) in FIG. 5a, and in terms of the power density (VA/m) in FIG. 5b. In FIG. 5a, it can be seen that the field is well focused, on the other side of the lens 1 with respect to the planar wave. FIG. 5b makes it possible to see that the focusing is done correctly, and just on the lens 1.

In the first specific embodiment of the antenna system according to the invention 6 shown in FIGS. 1a and 1b, the lens 1 is combined with a printed antenna array 5. The latter is, for example, optimized around 48.7 GHz.

As shown in FIG. 1b, the antenna system according to an embodiment of the invention also includes means for positioning the lens with respect to the printed antenna array. These positioning means include, for example:

a support (or base) 7, made of a foam material (of which the dielectric permittivity approximates that of air), and in which the lens 1 is embedded;

a metal base 8 on which the printed antenna array 5 rests;

spacers 9a, 9b made of foam material and making it possible to maintain a distance h between the external surface of the lens 1 and the patches of the printed antenna array 5. The distance h is discussed in detail below; and

screws 10a, 10b for assembling the support 7, the metal base 8 and the spacers 9a, 9b.

As shown in FIGS. 6a, 6b and 6c (seen in top, bottom and cross-section views, respectively), in order to obtain the desired directivities, the printed antenna array 5 (i.e. the lens excitation source) is, for example, made in the form of a structure including:

a feedline 65 printed on the lower surface of a first substrate layer 67;

a ground plane 69 with a slot 68, inserted between the first substrate layer 67 and a second substrate layer 66;

four patches 61 to 64 printed on the upper surface of the second substrate layer 66.

This antenna array is, for example, made on a ceramic PTFE substrate (RT Duroid 6006, εᵣ=7.0 and thickness=254 μm).

An example of a complete structure 6 according to the first embodiment mentioned above (combination of the antenna array 5 above with the Maxwell's fish-eye lens 1 according to the first line of the table above) was simulated with the 3D CST Microwave Study software (registered trademark) (based on the finite-difference time-domain method), and then measurements were taken.

A number of simulations of this antenna structure 6 example were performed by changing the distance h between these two elements so as to show the importance of this parameter. It is clear that the directivity can be quasi-stable on the frequency band considered if h is equal to 2.5 mm. Indeed, as the dielectric constant distribution is not continuous in the lens 1, the source array 5 cannot be found on the lens, but at a distance h substantially equal to the distance at which the focusing of the lens is done outside of the lens (see the description of FIGS. 4a, 4b, 5a and 5b above). This makes it possible to optimize the directivity on the frequency band considered. For example, it may be desirable for the directivity of the structure to be as stable as possible between 47.2 and 50.2 GHz (high-speed satellite communication application).

It is important to note that, according to the source used (array, single patch, etc.) and according to the constitution of the lens (number of shells, radii and dielectric constants), the height h between the source and the lens varies because the focusing zone is not necessarily located in the same place.

The measurements taken in the aforementioned example of the complete structure 6 show that the presence of the lens 1 does not degrade the adaptation obtained with the antenna array 5 alone. They also show that the maximum gain obtained is 16.4 dB around 49 GHz. The efficacy (45%) deduced therefrom is due only to the losses caused by the materials used (PTFE polymer, copper, etc.).

Now, it is important to look at the surface efficacy of this antenna. Naturally, the lenses have relatively limited surface efficiencies due to their large sizes. To calculate the surface efficacy of the lens, it is necessary to consider a radiating opening of the same size as the lens, namely 24 mm, and to calculate the associated directivity. The latter is given by the following formula:

$${D}_{db} = 20 log ( \frac{π d}{λ} )$$

where γ is the wavelength in a vacuum and d is the diameter of the opening. Consider, for example, the central frequency of the band, i.e. 48.7 GHz. The directivity obtained with a lens having a diameter of 24 mm is 21.7 dBi. However, the directivity of the lens calculated with the 3D CST Microwave Studio software is 19.9 dBi at the same frequency. These results make it possible to conclude a surface efficiency of 66%. This result is highly satisfactory for a lens in these high-frequency bands. To conclude, the overall efficiency of the aforementioned example of a complete structure 6 is therefore around 30% at the frequency of 48.7 GHz.

We will now present an alternative embodiment of the lens source, i.e. and alternative to the printed antenna array discussed above and shown in FIGS. 6a and 6b.

If the surface efficiency obtained is very good (66%), the efficiency due to losses (45%) is lower. However, the losses are essentially caused by the printed array, which serves as a source for the lens. The solution in order to increase the overall efficiency is therefore to use a substrate with very low losses, such as quartz, for example, or to limit the line lengths of the tree structure of the array. This last remark led the inventors to study an original solution for the source of the lens. Indeed, they decided to use only a single printed patch to feed the lens. However, in this case, the pattern of the source is therefore very wide, which means there are signal spill-over and back-radiation problems In addition, the overall directivity is much lower than with an array of four elements.

The solution to this problem works in the use of a single patch printed on air and fed through a slot. In this case, the dielectric losses are absent and the directivity of this type of patch is high (9-10 dBi) due to the very low permittivity of the substrate (air).

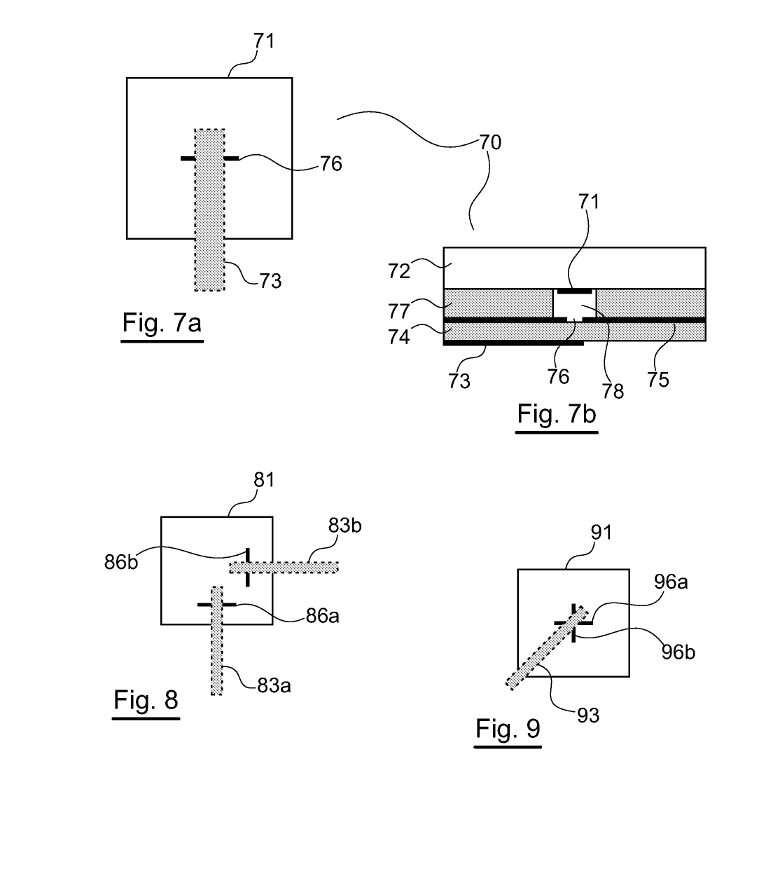

FIGS. 7a and 7b show a bottom view and a cross-section view, respectively, of a first embodiment of a patch printed on air (non-conformal, vertical linear polarization), capable of being combined with a Maxwell's fish-eye lens according to an embodiment of the invention.

The printed patch 70 is made in the form of a structure including:

a feedline 73 printed on the lower surface of a first substrate layer 74;

a ground plane 75 with a slot 76, inserted between the first substrate layer 74 and a second substrate layer 77;

an air cavity 78 formed in the second substrate layer 77;

a third foam substrate layer 72 with a very low permittivity (1.45), used as a support for the patch 71, so that the patch is located above the air cavity 78.

The input impedance of this printed patch 70 was simulated with the CST Microwave Study software, between 40 and 55 GHz. It results from this simulation that the printed patch 70 is well adapted to the band considered (47.2 GHz-50.2 GHz). The directivity obtained is stable in the frequency band and is equal to 9 dBi. The latter is high due to the fact that the patch is printed on air.

The next step consisted of combining this printed patch 70 with an example of an inhomogeneous lens according to an embodiment of the invention (with a diameter of 24 mm). The support of the printed patch in this case has a height of 1 mm, because this height h between the patch and the lens makes it possible to obtain a beneficial directivity for the assembly, and quasi-stable at the frequency band considered.

The complete structure was simulated on CST. The radiation diagrams calculated at 48.7 GHz make it possible to show the very clear effect of this focusing. Indeed, the openings at half-power obtained are respectively 23.1° and 19.1°. The level of the secondary lobes is satisfactory, on the order of −18 dB with respect to the main lobe. Concerning the directivity, the values obtained between 47 and 50 GHz are between 17.7 dBi and 18.4 dBi. The directivity is therefore stable on the band of interest. The lens excited by a single printed patch is a highly beneficial device because it makes it possible to obtain very good radiation characteristics (openings, lobes, directivity) by comparison with the solution including an array of four sources. In addition, the losses due to the substrate of the source are reduced because the printed surfaces are smaller. This makes it possible to increase the overall efficiency of the structure, which was one of the objectives.

The printed patch that excites the lens fixes the type of polarization. In the case of FIGS. 7a and 7b, the polarization obtained is vertical linear. Other polarizations can be envisaged.

It is entirely possible to obtain a horizontal linear polarization, and even, as shown in FIG. 8, to create a bipolarization with two feedlines 83a, 83b of the same patch 81. Each feedline excites the patch 81 via a distinct slot 86a, 86b, with the two slots being mutually orthogonal so as to excite two orthogonal modes.

As shown in FIG. 9, it is similarly entirely possible to consider obtaining a circular polarization. In this case, the patch 91 is almost square, and two orthogonal slots 96a and 96b (cross-slots) are etched in the same ground plane and fed by a single feedline 93, which makes it possible to create modes phase shifted by 90° at a frequency, and thus to create a circular polarization.

FIG. 10 shows a cross-section view of a second particular embodiment of an antenna system according to the invention, combining a Maxwell's fish-eye lens 1 according to an embodiment of the invention with an antenna array 106.

In this second embodiment, the means for positioning the lens 1 with respect to the printed antenna array 106 include:

an additional shell 101, having a shape fitting the external surface of the lens 1, made with a substrate of which the dielectric permittivity approximates that of air, and which can be metallized (so as to be capable of receiving one or more radiating patches);

a support (or base) 102 made of a foam material (of which the dielectric permittivity approximates that of air), and in which the lens 1 is embedded, surrounded by the additional shell 101;
a metal base 103;
spacers 104a, 104b made of a foam material and making it possible to maintain a predetermined distance (not to be confused with the height h, as explained below) between the lens 1 and the metal base 8; and
screws 105a, 105b for assembling the support 102, the metal base 103 and the spacers 104a, 104b.

The printed antenna array 106 is the type presented above in relation to FIGS. 6a and 6b, but is distinguished therefrom in that at least one part of this array is conformed directly to the external surface of the additional shell 101.

In the example shown in FIG. 10, patches 107, 108 are conformed at the external surface of the additional shell 101. It is thus the thickness of the additional shell 101 that gives the height h between the lens 1 and the printed antenna array. It is important to note that, given the very reduced size of the patches with respect to the radius of the half-sphere constituting the lens 1, the curve of the metal patches is low and does not notably modify the results of the planar case.

Moreover, the rest of the antenna array (namely a substrate layer 110 on the lower surface of which a feedline 109 is printed and on the upper surface of which a ground plane 11 with a slot 112 rests) rests on the metal base 103. It is noted that the air-filled space between the conformed patches 107, 108 and the ground plane 11 with the slot 112 performs the same role as the substrate layer referenced 66 in FIG. 6c.

In an alternative embodiment (not shown), the entire printed antenna array is conformed to the external surface of the additional shell 101.

In another alternative of the second embodiment of the antenna system according to the invention, the source associated with the lens is a single antenna printed on air, conformed at least partially to the external surface of the additional shell 101.

In general, and regardless of the embodiment used (first or second), the system of the invention (combination of a lens with at least one source antenna) is not related to a particular type of antenna. In other words, this system can be implemented, for example, with one or more printed antennas (single- or multi-layer), one or more waveguides, one or more horns, one or more wire antennas, etc. The optimization of the source makes it possible to optimize the radiation diagram of the “antenna-lens”, and thus to adjust the directivity, the level of the secondary lobes and the opening at −3dB. In particular, the patch(es) are not necessarily excited through the slot(s), but can be excited directly by one or more feedlines.

Optionally, the antenna system according to an embodiment of the invention also includes means for de-centering the source (for example, a printed antenna array or a single patch printed on air) with respect to the axis of the lens, enabling the source to consecutively occupy at least two different positions contained in the focal spot. This allows for scanning, on a small angular sector, of the beam focused at the output of the lens. This scanning makes it possible to obtain multi-beam patterns or to shift the beam.

It is noted that the lens of the invention, regardless of its embodiment, has a focal spot due to the fact that the index distribution obtained with N concentric shells is discrete. This focal spot is located outside the lens and at a predetermined distance h from the lens. The de-centering means exist, for example, in mechanical form (any means allowing for a physical movement of the source with respect to the lens) or in electronic form (movement of the beam from the source by switching between elements of an antenna array, of the smart antenna type).

The physical movement of the source with respect to the lens is achieved by a rotation or translation movement of the source with respect to the lens.

It is noted that, theoretically, the so-called Maxwell's fish-eye lens has only a single focal point and does not make it possible to shift the beam or to obtain multi-beam patterns. However, as the law of the index in the lens produced according to an embodiment of the invention is discrete, it is in fact a focal spot that is obtained (see FIGS. 4a and 5a). The fact that there is a focal spot makes it possible to move the source under the lens and thus to obtain a shifting of the beam or a multi-beam diagram.

This additional innovation provided by the lens of an embodiment of the invention was tested by simulation. The source was moved a few millimeters in both direction.

For this simulation, the source used is again the printed antenna array with four elements (see FIGS. 6a and 6b). The idea is therefore to change the position of this source under the lens so as to see whether the radiation diagram of the assembly combining the source and the lens can, for example, shift over a certain angular sector. The constraints are to preserve a relatively low level of secondary lobes and a sufficient directivity. A number of movements of the source with respect to the lens were considered (d=1.2 or 3 mm), and these cases were simulated. The case in which the array is shifted by 2 mm with respect to the axis of the lens is presented below. The simulation results are very encouraging since the beam shifts around 10° at 47.2 GHz. The level of the secondary lobes remains highly satisfactory (−20 dB) and the directivity is 18.5 dBi.

Additional simulations consisted of shifting the beam along both axes. To do this, the position of the source under the lens was changed in both directions x and y. The source was thus moved 2 and 3 mm, respectively, along both axes. The radiation diagram obtained clearly shows that the beam is shifted in both planes.

These results are highly satisfactory because they demonstrate the feasibility of a beam-shifting antenna, and even a multi-beam antenna based on a Maxwell's fish-eye lens, and therefore a significant size reduction with respect to the Lüneburg lens, for example, which also allows for this functionality.

The antenna structure according to an embodiment of the invention can, for example, be used in satellite reception (band 12-14 GHz). Indeed, currently, when a client wants to receive two different satellites, two switchable sources illuminating the parabola are necessary. The solution of an embodiment of the invention makes it possible to have only one source (lens illuminated by a printed antenna array, for example) of which the diagram can shift so as to aim at both satellites.

The antenna structure according to an embodiment of the present invention (combination of at least one source antenna with a Maxwell's fish-eye lens) can also make it possible to easily obtain multi-beam diagrams by changing the position of the source with respect to the axis of the lens. This aspect is particularly interesting because numerous applications may require the use of multi-beam antennas: anti-collision radars for motor vehicles (77 GHz), indoor communications (60 GHz), satellite television reception, high-speed space communications, and so on.

At least one embodiment of the present invention provides a technique for producing a Maxwell's fish-eye lens that is mechanically simple and inexpensive. An embodiment of the invention is also intended to theoretically provide a way of choosing the number and the type of materials used to produce a Maxwell's fish-eye lens, and to thus generalize the production technique.

An embodiment of the invention is also intended to provide an antenna system including a lens thus produced, that is itself easy to produce and inexpensive.

An embodiment of the invention is also intended to provide such an antenna system that, in an embodiment in which the source is constituted by one or more printed antennas, makes it possible to obtain a beneficial directivity while limiting the printed surfaces, which makes it possible to reduce the losses caused by the printed source.

A particular embodiment of the invention provides an antenna system that has a minimal compactness.

A particular embodiment provides an antenna system that allows for scanning of the beam focused at the output of the lens, making the antenna system capable of being used in all applications requiring the beam to be shifted or a multi-beam radiation pattern to be obtained.

Although the present disclosure has been described with reference to one or more examples, workers skilled in the art will recognize that changes may be made in form and detail without departing from the scope of the disclosure and/or the appended claims.

1. Inhomogeneous lens with a gradient index, of the Maxwell's fish-eye type, produced in the form of a semi-sphere, wherein the lens includes N semi-spherical concentric shells, with different discrete dielectric constants overlapping one another without any empty spaces between two successive shells, with 3≦N≦20, wherein the discrete dielectric constants of the N shells are such that they define a discrete distribution approximating the theoretical distribution of the index inside the lens.

2. Lens according to claim 1, wherein the N shells have discrete dielectric constants ε₁, ε₂ . . . ε_{N} and standardized external radii d₁, d₂ . . . d_{N}, with d_{N}=1, so that they minimize the following function:
Δ=∫₀^{d}^{₁}|εᵣ(r)−ε₁|^{q}dv+∫_{d}_{₁}^{d}^{₂}|εᵣ(r)−ε₂|^{q}dv+ . . . +∫_{d}_{_{N-1}}¹|εᵣ(r)−ε_{N}|^{q}dv
with q=∞ and in which:
$${\vert {ɛ}_{r} ( r ) - {ɛ}_{i} \vert}^{∞} = {sup}_{r ∈ [ {r}_{1 - 1} , {r}_{i} ]} \vert {ɛ}_{r} ( r ) - {ɛ}_{i} \vert ,$$
with i representing the number of the shell concerned
dv=2πr²dr
εr( ) is the theoretical distribution of the index inside of the lens, and dv is a volume element.

3. Lens according to claim 1, wherein the lens includes three shells, called a central shell, an intermediate shell and an external shell, of which the standardized external radii are respectively: d₁, d₂ and d₃, and of which the standardized radial thicknesses are respectively equal to: d₁, d₂−d₁, and d₃−d₂ to the nearest hundredth.

4. Lens according to claim 3, wherein the standardized external radii are respectively equal to: d₁=0.43, d₂=0.70 and d₃=1 to the nearest hundredth, and the dielectric constants of the central, intermediate and external shells are respectively equal to 3.57, 2.72 and 1.86 to the nearest hundredth.

5. Antenna system, wherein the antenna system includes a lens according to claim 1, combined with at least one source antenna.

6. System according to claim 5, wherein said at least one source antenna belongs to the group including:
printed antennas;
waveguides;
horn antennas; and
wire antennas.

7. System according to claim 5, wherein said lens has a focal spot due to the fact that the index distribution obtained with said concentric shells is discrete, said focal spot being located outside the lens and at a predetermined distance h from the lens,
wherein said system includes positioning means making it possible to place said at least one source antenna at said distance h from the lens, and in a position contained in said focal spot.

8. System according to claim 7, wherein said positioning means include at least one spacer made of a dielectric material of which the dielectric permittivity approximates that of the air and makes it possible to position the lens with respect to said at least one source antenna.

9. System according to claim 7, wherein said positioning means include an additional shell, of which the dielectric permittivity approximates that of the air, having a shape fitting the external surface of the lens, and at least one portion of said source antenna being conformed directly to the external surface of said additional shell.

10. System according to claim 7, wherein the system includes a single source antenna that is an antenna printed on air and fed through a slot.

11. System according to claim 5, wherein said lens has a focal spot due to the fact that the index distribution obtained with said concentric shells is discrete, said focal spot being located outside the lens and at a predetermined distance h from the lens, wherein the system also includes means for de-centering said at least one source antenna with respect to the axis of the lens, enabling said at least one source antenna to successively occupy at least two different positions contained in said focal spot, so as to allow for scanning, over an angular sector, of the beam focused at an output of the lens.

12. Application of the antenna system according to claim 11 to shift the beam at the output of the lens.

13. Application of the antenna system according to claim 11 to obtain a multi-beam diagram.

14. A method comprising:
providing an antenna system, which includes an inhomogeneous lens combined with at least one source antenna, wherein:
the inhomogeneous lens has a gradient index, of the Maxwell's fish-eye type, produced in the form of a semi-sphere,
the lens includes N semi-spherical concentric shells, with different discrete dielectric constants overlapping one another without any empty spaces between two successive shells, with 3≦N≦20, wherein the discrete dielectric constants of the N shells are such that they define a discrete distribution approximating the theoretical distribution of the index inside the lens, and
wherein said lens has a focal spot due to a fact that an index distribution obtained with said concentric shells is discrete, said focal spot being located outside the lens and at a predetermined distance h from the lens, and
de-centering said at least one source antenna with respect to an axis of the lens, enabling said at least one source antenna to successively occupy at least two different positions contained in said focal spot, so as to allow for scanning, over an angular sector, of the beam focused at an output of the lens.

15. The method of claim 14, wherein the method further comprises shifting the beam at the output of the lens.

16. The method of claim 14, wherein the method further comprises applying the antenna system to obtain a multi-beam diagram.
